(19) United States
(12) Patent Application Publication
(10) Pub. No.: US 2011/0272523 A1
(43) Pub. Date: Nov. 10, 2011

(54) SHOCK ABSORPTION SYSTEM

(76) Inventor: Kenji Uegaki, Aichi (JP)

(21) Appl. No.: 13/144,313

(22) PCT Filed: Jan. 18, 2009
(86) PCT No.: PCT/JP2009/050669

§ 371 Date: Jul. 13, 2011

(51) Int. Cl. B64C 25/56

(52) U.S. Cl. 244/100 A

(57) ABSTRACT

An air bag 4 is inflated in a shock absorption system 1 by a high pressure air cylinder 5 at the time of a collision between an aircraft and the ground that is caused by inability to fly or the like, so that a cover body 2 is unfolded to the outside from a bottom portion 11a of a fuselage 11 of the aircraft 10 and the air bag 4 is disposed inside the cover body 2. Accordingly, a sufficient shock absorption stroke is obtained, so that it may be possible to reliably absorb shock that is generated at the fuselage 11 during the collision between the aircraft and the ground caused by an inability to fly or the like. Further, the cover body 2 is unfolded from the bottom portion 11a of the fuselage 11 so as to spread out toward the rear side of the aircraft 10. Accordingly, it may be possible to make the fuselage 11 smoothly slide on the ground during the collision between the aircraft and the ground that is caused by an inability to fly or the like. Therefore, according to the shock absorption system 1, it may be possible to prevent the fuselage 11 of the aircraft 10 from being damaged during the collision between the aircraft and the ground that is caused by an inability to fly or the like.

### TECHNICAL FIELD

The present invention relates to a shock absorption system that is mounted on an aircraft.

### BACKGROUND ART

A technique, which makes an aircraft make a soft landing by unfolding a parachute or an air bag during an emergency caused by an inability to fly or the like, has been known in the past (for example, see Patent Literature 1).

### CITATION LIST

### Patent Literature

[Patent Literature 1] Japanese Unexamined Patent Application Publication No. 2004-051070

### SUMMARY OF INVENTION

### Technical Problem

However, in the above-mentioned technique, there is a concern that a parachute may not sufficiently function due to a lack of altitude or an air bag may be torn due to the contact between the air bag and the ground, so that the fuselage of the aircraft is damaged.

The invention has been made in consideration of the above-mentioned circumstances, and an object of the invention is to provide a shock absorption system that can prevent the fuselage of an aircraft from being damaged during the collision between the aircraft and the ground caused by an inability to fly or the like.

### Solution to Problem

In order to achieve the above-mentioned object, according to the invention, there is provided a shock absorption system that is mounted on an aircraft. The shock absorption system includes a cover body that is provided at a bottom portion of the fuselage of the aircraft, an unfolding means that unfolds the cover body to the outside from the bottom portion, and a shock absorption body that is disposed inside the cover body when the cover body is unfolded by the unfolding means. The cover body is unfolded from the bottom portion so as to spread out toward the rear side of the aircraft.

In the shock absorption system, the cover body is unfolded to the outside from the bottom portion of the fuselage of the aircraft by the unfolding means and the shock absorption body is disposed inside the cover body. Accordingly, a sufficient shock absorption stroke is obtained, so that it may be possible to reliably absorb shock that is generated at the fuselage of the aircraft during the collision between the aircraft and the ground caused by an inability to fly or the like. Further, the cover body is unfolded from the bottom portion of the fuselage of the aircraft so as to spread out toward the rear side of the aircraft. Accordingly, it may be possible to reduce deceleration in the longitudinal direction, which is caused by the sudden stop of the fuselage, by making the fuselage of the aircraft smoothly slide during the collision between the aircraft and the ground that is caused by an inability to fly or the like. Therefore, according to the shock absorption system, it may be possible to prevent the fuselage of the aircraft from being damaged during the collision between the aircraft and the ground that is caused by an inability to fly or the like.

Further, the shock absorption system may further include a determination means that determines whether the cover body can be unfolded. If the determination means determines that the cover body can be unfolded, the unfolding means may unfold the cover body. According to this structure, if the cover body can be unfolded (for example, the aircraft can belly-land) during the collision between the aircraft and the ground that is caused by an inability to fly or the like, it may be possible to reliably unfold the cover body in a timely manner.

In this case, the determination means may determine whether the cover body can be unfolded, on the basis of a landing state of a landing gear portion of the aircraft. According to this structure, it may be possible to unfold the cover body in a more timely and reliable manner during the collision between the aircraft and the ground that is caused by an inability to fly or the like.

Furthermore, the shock absorption body may be an air bag that contracts while absorbing shock, or the shock absorption body may be a pipe member that contracts in the axial direction while absorbing shock. According to this structure, it may be possible to easily and reliably absorb shock.

### Advantageous Effects of Invention

According to the invention, it may be possible to prevent the fuselage of an aircraft from being damaged during a collision between the aircraft and the ground caused by an inability to fly or the like.

### BRIEF DESCRIPTION OF DRAWINGS

FIG. 1 is a side view of an aircraft on which a shock absorption system according to a first embodiment is mounted.

FIG. 2 is a side view of another aircraft on which the shock absorption system according to the first embodiment is mounted.

FIG. 3 is a side view of an aircraft on which a shock absorption system according to a second embodiment is mounted.

FIG. 4 is a side view of a pipe structure including a plurality of pipe members that is connected to each other.

### DESCRIPTION OF REFERENCE SIGNS

1: shock absorption system
2: cover body
4: air bag (shock absorption body)
5: high pressure air cylinder (unfolding means)
9: controller (determination means)
10: aircraft
11: fuselage
11a: bottom portion
15: nose landing gear (landing gear portion)
21: pipe member (shock absorption body)
24: small parachute (unfolding means)

### DESCRIPTION OF EMBODIMENTS

Preferred embodiments of the invention will be described in detail below with reference to the drawings. Meanwhile, the same elements in the respective drawings are denoted by the same reference numerals, and repeated descriptions will be omitted.

### First Embodiment

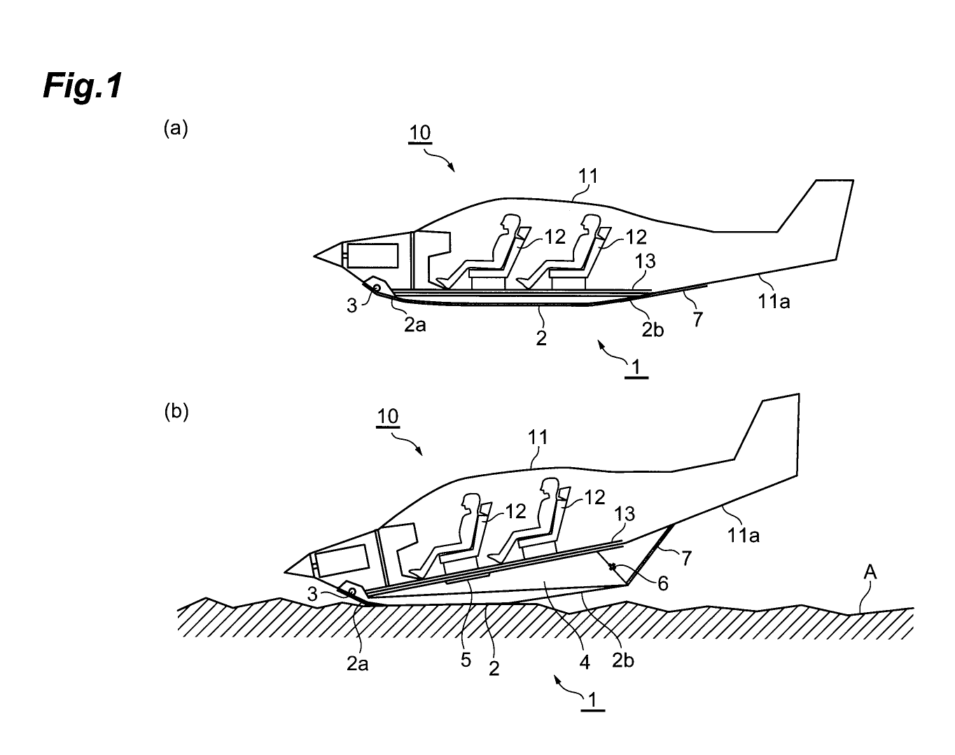

FIG. 1 is a side view of an aircraft on which a shock absorption system according to a first embodiment is mounted. As shown in FIG. 1, an aircraft 10 is a fixed-wing aircraft and a shock absorption system 1 is mounted on a bottom portion 11a of the fuselage 11 of the aircraft 10. The shock absorption system 1 is positioned below a floor 13 to which seats 12 for occupants are fixed in the fuselage 11.

The shock absorption system 1 includes a cover body 2 that is provided at the bottom portion 11a of the fuselage 11. The cover body 2 forms a part of a fuselage wall of the bottom portion 11a, and has a streamlined shape that gently swells outward. A front end portion 2a of the cover body 2 is supported by a pivot 3 so as to be rotatable relative to the fuselage 11. Accordingly, the cover body 2 is unfolded from the bottom portion 11a so as to spread out toward the rear side of the aircraft 10. In other words, the cover body 2 is unfolded so that the distance between the cover body 2 and the bottom portion 11a increases toward the rear side of the aircraft 10. Meanwhile, the cover body 2 may be, for example, a skid structure that is provided separately from the fuselage wall of the bottom portion 11a.

An air bag (shock absorption body) 4 is disposed between the cover body 2 and the floor 13. The air bag 4 is inflated with a load of about 50 G×1 ton by a high pressure air cylinder (unfolding means) 5 so as to have an internal pressure of about 2 to 5 barr. At this time, the cover body 2 is unfolded to the outside from the bottom portion 11a of the fuselage 11. That is, the air bag 4 is disposed inside the cover body 2 when the cover body 2 is unfolded by the action of the high pressure air cylinder 5. The air bag 4 is provided with a pressure regulating valve 6 so that the air bag 4 contracts while absorbing shock when the shock is applied to the cover body 2 unfolded by the inflation of the air bag. Meanwhile, the air bag 4 may be inflated by gunpowder or the like instead of a high pressure air cylinder 5.

An elastic cover member 7 is fixed to a rear end portion 2b of the cover body 2 so as to be stretched between the fuselage 11 and the rear end portion 2b of the cover body 2. When the cover body 2 is unfolded, the cover member 7 is unfolded from the bottom portion 11a so as to be tapered toward the rear side of the aircraft 10. In other words, when the cover body 2 is unfolded, the cover member 7 is unfolded so that the distance between the cover member 7 and the bottom portion 11a decreases toward the rear side of the aircraft 10. Accordingly, even if the cover body 2 is unfolded during the flight of the aircraft due to an erroneous operation, the rear portion of the fuselage 11 becomes aerodynamically smooth. Therefore, the aircraft can continue to fly. Meanwhile, if the cover member 7 is stretched not only between the fuselage 11 and the rear end portion 2b of the cover body 2 but also between the fuselage 11 and side end portions of the cover body 2, it may be possible to make not only the rear portion of the fuselage 11 but also the side portions of the fuselage 11 become aerodynamically smooth.

In the shock absorption system 1 having the above-mentioned structure, the cover body 2 is closed during usual flight of the aircraft (see FIG. 1A). However, the air bag 4 is inflated during an emergency, which is caused by an inability to fly or the like, by the high pressure air cylinder 5 through, for example, input from the pilot (operation of a button or the like) as a trigger, so that the cover body 2 is unfolded to the outside from the bottom portion 11a of the fuselage 11 of the aircraft 10 and the air bag 4 is disposed inside the cover body 2 (see FIG. 1B). Accordingly, a shock absorption stroke sufficient for the reduction of vertical G (deceleration G in the vertical direction of the fuselage), which is caused by the collision between the aircraft and the ground A, is obtained, so that it may be possible to reliably absorb shock that is generated at the fuselage 11 during the collision between the aircraft and the ground caused by an inability to fly or the like.

For example, if the shock absorption system 1 is not mounted on the aircraft 10, the front end portion of the bottom portion 11a of the fuselage 11 collides with the ground, so that the vertical speed of the fuselage becomes zero at the front end portion of the bottom portion. Accordingly, the rear end portion of the bottom portion 11a of the fuselage 11 is rotated, so that acceleration is generated toward the lower side. For this reason, when the rear end portion of the bottom portion 11a of the fuselage 11 collides with the ground, larger vertical G is generated. In contrast, if the shock absorption system 1 is mounted on the aircraft 10, it may be possible to suppress the above-mentioned rapid rotation of the rear end portion of the bottom portion 11a of the fuselage 11.

Further, in the shock absorption system 1, the cover body 2 is unfolded from the bottom portion 11a of the fuselage 11 of the aircraft 10 so as to spread out toward the rear side of the aircraft 10 (see FIG. 1B). Accordingly, it may be possible to make the fuselage 11 of the aircraft 10 smoothly slide on the ground A during the collision between the aircraft and the ground that is caused by an inability to fly or the like. That is, it may be possible to prevent the aircraft 10 from being inclined forward or to prevent longitudinal deceleration G (deceleration G in the axial direction of the fuselage) from being suddenly generated due to the embedding, catching, or the like of the fuselage 11 into the ground A.

Therefore, according to the shock absorption system 1, it may be possible to prevent the fuselage 11 of the aircraft 10 from being damaged during the collision between the aircraft and the ground that is caused by an inability to fly or the like. Further, it may be possible to improve passenger safety.

Meanwhile, if a frictional resistance reducing layer, which is separated or abraded by the friction between the ground A and itself, is formed on the outer surface of the cover body 2, the frictional resistance reducing layer and the streamlined shape of the cover body 2 may make the fuselage 11 of the aircraft 10 smoothly slide on the ground A during the collision between the aircraft and the ground that is caused by an inability to fly or the like. As the frictional resistance reducing layer, wood of which the fiber direction corresponds to the friction direction; a resin material having an abrasion property or low friction; a member where a plurality of small rod-like members, which are made of a hard resin, have a circular cross-section, and are disposed parallel to the circumferential direction of the fuselage perpendicular to the axial direction of the fuselage, and is fixed by a softer resin; and the like are exemplified.

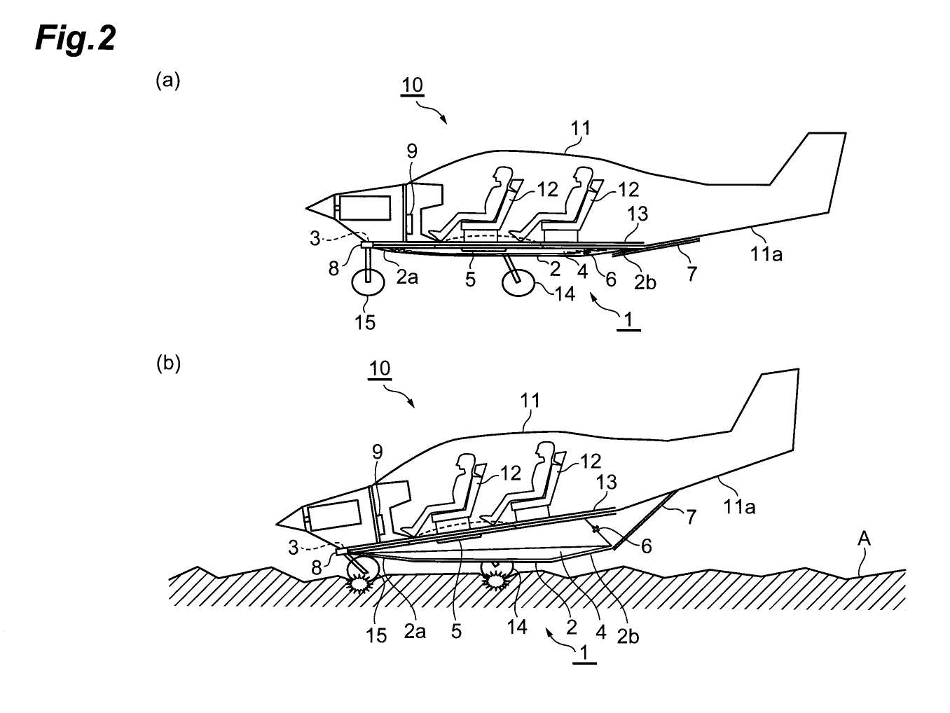

Next, a modification of the shock absorption system 1, which uses the air bag 4 as a shock absorption body, will be described. FIG. 2 is a side view of another aircraft on which the shock absorption system according to the first embodiment is mounted. As shown in FIG. 2, the aircraft 10 is a fixed landing gear aircraft and includes main landing gears 14 and a nose landing gear (landing gear portion) 15. The shock absorption system 1 includes a load detector 8 that is fixed to a support leg of the nose landing gear 15, and a controller (determination means) 9 that controls the high pressure air cylinder 5 and the pressure regulating valve 6.

The controller 9 calculates the operation timing of the high pressure air cylinder 5 where the air bag 4 can be appropriately inflated, and pressure reduction characteristics of the pressure regulating valve 6 where the air bag 4 can appropriately contract while absorbing shock on the basis of a collision signal transmitted from the load detector 8 (a signal representing a load or acceleration generated at the support leg of the nose landing gear 15) and a fuselage flight instrument signal transmitted from the aircraft 10 (a signal representing fuselage speed or fuselage attitude). Further, the controller 9 operates the high pressure air cylinder 5 at the calculated operation timing and adjusts the opening of the pressure regulating valve 6 so that the calculate pressure reduction characteristics are shown.

That is, in the shock absorption system 1, the controller 9 determines whether the aircraft 10 can belly-land using a collision signal, which is transmitted from the load detector 8, as a trigger signal on the basis of the landing state of the nose landing gear 15 of the aircraft 10. Further, if the controller 9 determines that the aircraft can belly-land, the air bag 4 is inflated by the high pressure air cylinder 5 and the cover body 2 is unfolded. Accordingly, it may be possible to reliably unfold the cover body 2 in a timely manner during the collision between the aircraft and the ground that is caused by an inability to fly or the like (for example, during the collision between the aircraft and the ground A or immediately before the collision between the aircraft and the ground). Moreover, it may be possible to prevent the erroneous unfolding of the cover body, which is caused by erroneous detection, by using the physical fracturing of the nose landing gear 15, which is caused by the collision between the ground and the nose landing gear, as a trigger signal.

Meanwhile, if the loss of the speed of the aircraft 10 is detected, the controller 9 may determine that the aircraft can belly-land. Further, the controller 9 determines whether the cover body 2 can be unfolded, and the cover body 2 may be unfolded if the controller 9 determines that the cover body can be unfolded. Furthermore, if the aircraft 10 is a retractable landing gear aircraft, the load detector 8 may be fixed to an antenna-like protrusion formed at the front end portion of the bottom portion 11a of the fuselage 11 or a radio range finding method may be employed in order to acquire a collision signal. Moreover, the controller 9 determines a state or an area where the aircraft may collide with the ground, on the basis of signals that are transmitted from an altimeter, a GPS, a radio altimeter, a speedometer, a gyro attitude indicator, and the like; and can prevent an erroneous operation, which is caused by the collision between the aircraft and birds or the like during the flight of the aircraft, by employing only a collision signal, which is transmitted under the above-mentioned state or in the above-mentioned area, as a trigger signal.

### Second Embodiment

A shock absorption system according to a second embodiment is mainly different from the above-mentioned shock absorption system according to the first embodiment in that a pipe member is used as the shock absorption body. The shock absorption system according to the second embodiment will be described in terms of this difference.

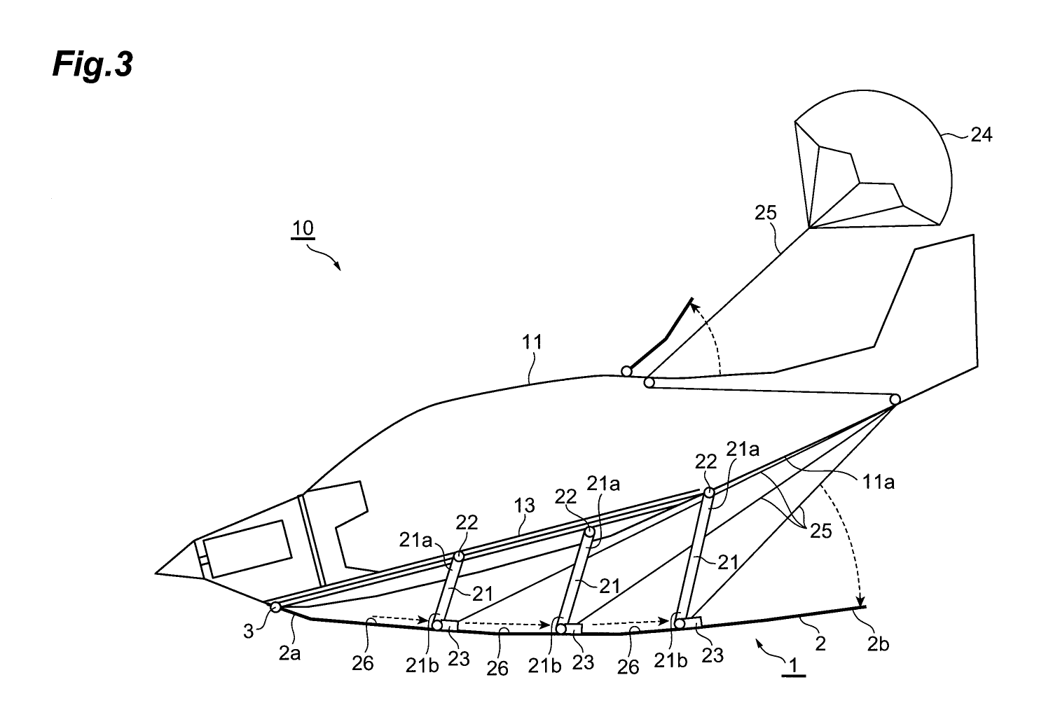

FIG. 3 is a side view of an aircraft on which a shock absorption system according to a second embodiment is mounted. As shown in FIG. 3, a shock absorption system 1 includes a plurality of pipe members (shock absorption bodies) 21 that is disposed in a cover body 2 when the cover body 2 is unfolded. One end portion 21a of each of the pipe members 21 is supported by a pivot 22 so as to be rotatable relative to the lower portion of a floor 13 of a fuselage 11. When the cover body 2 is unfolded, the other end portion 21b of each of the pipe members 21 is locked by the respective lock mechanism 23 that is provided on the cover body 2 and disposed at a predetermined position when a guide mechanism 2b is made to slide. The pipe member 21 is made of carbon fiber reinforced plastic (CFRP). When shock is applied to the unfolded cover body 2, progressive fracturing in the axial direction occurs at the members 21 and the members 21 contract in the axial direction while absorbing the shock.

During usual flight of the aircraft, the pipe members 21 are received below the floor 13 while being parallel to the axial direction of the fuselage. During the collision between the aircraft and the ground that is caused by an inability to fly or the like, the members support the cover body 2 while crossing the axial direction of the fuselage. More specifically, when a small parachute (unfolding means) 24 is unfolded during the collision between the aircraft and the ground that is caused by an inability to fly or the like, the other end portions 21b of the pipe members 21 are pulled by a wire 25 connected to the small parachute 24, slide along guide mechanisms 26 provided on the cover body 2, and are locked by the lock mechanisms 23. Meanwhile, a compressed air actuator, rubber, a spring, gunpowder, an electric motor, or the like may be used as a power source, instead of the small parachute 24.

In the shock absorption system 1 having the above-mentioned structure, the cover body 2 is closed during the usual flight of the aircraft. However, the small parachute 24 is unfolded during the collision between the aircraft and the ground that is caused by an inability to fly or the like through, for example, input from the pilot (operation of a button or the like) as a trigger, so that the cover body 2 is unfolded to the outside from the bottom portion 11a of the fuselage 11 of the aircraft 10 and the extended pipe members 21 are disposed inside the cover body 2 at predetermined angles (angles set so that the axial directions of the pipe members 21 correspond to the direction where an impulsive force is input). Accordingly, a shock absorption stroke sufficient for the reduction of vertical G (deceleration G in the vertical direction of the fuselage), which is caused by the collision between the aircraft and the ground A, is obtained, so that it may be possible to reliably absorb shock that is generated at the fuselage 11 during the collision between the aircraft and the ground caused by an inability to fly or the like.

Further, in the shock absorption system 1, the cover body 2 is unfolded from the bottom portion 11a of the fuselage 11 of the aircraft 10 so as to spread out toward the rear side of the aircraft 10. Accordingly, it may be possible to make the fuselage 11 of the aircraft 10 smoothly slide on the ground A during the collision between the aircraft and the ground that is caused by an inability to fly or the like. That is, it may be possible to prevent the aircraft 10 from being inclined forward or to prevent longitudinal deceleration G (deceleration G in the axial direction of the fuselage) from being suddenly generated due to the embedding, catching, or the like of the fuselage 11 into the ground A.

Therefore, according to the shock absorption system 1, it may be possible to prevent the fuselage 11 of the aircraft 10 from being damaged during the collision between the aircraft and the ground that is caused by an inability to fly or the like. Further, it may be possible to improve passenger safety.

Meanwhile, glass fiber reinforced plastic (GFRP), organic fiber reinforced plastic such as aramid, and the like other than CFRP are exemplified as the material of the pipe member 21. Further, a metal pipe member where a plurality of horizontal beads, which become the starting points of plastic deformation in the shape of a bellows, is provided; a hydraulic damper mechanism (a member having the shape of a shock absorber) where an orifice is provided; a pipe structure formed of a plurality of metal pipe members that is connected to each other, and the like may be used instead of the pipe member 21.

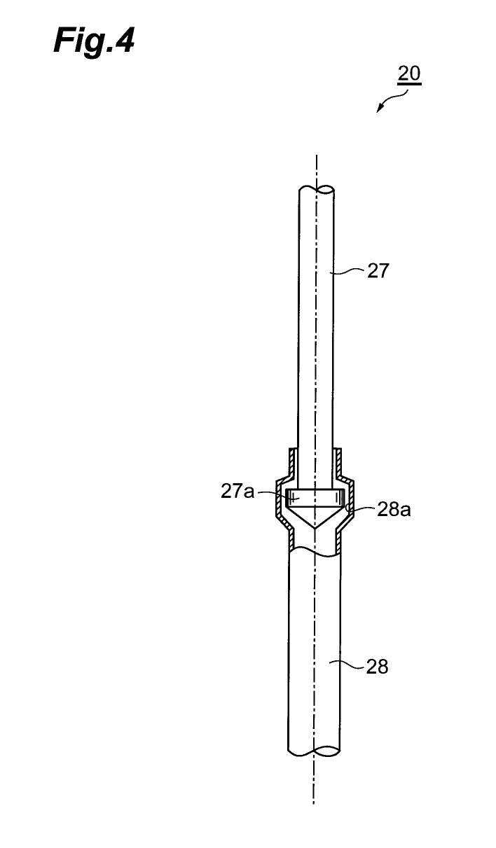

FIG. 4 is a side view of a pipe structure including a plurality of pipe members that is connected to each other. As shown in FIG. 4, a pipe structure 20 includes a plurality of pipe members 27 and 28 that is connected to each other. In the pipe structure 20, a large diameter portion 27a of an inner pipe member 27 is disposed in an enlarged diameter portion 28a of an outer pipe member 28. Accordingly, when shock is applied to the pipe structure 20 in the axial direction, the pipe structure 20 contracts while being subjected to metal plastic deformation and absorbing shock.

### INDUSTRIAL APPLICABILITY

According to the invention, it may be possible to prevent the fuselage of an aircraft from being damaged during the collision between the aircraft and the ground that is caused by an inability to fly or the like.

1. A shock absorption system that is mounted on an aircraft, the shock absorption system comprising:
a cover body that is provided at a bottom portion of a fuselage of the aircraft;
an unfolding means that unfolds the cover body to the outside from the bottom portion; and
a shock absorption body that is disposed inside the cover body when the cover body is unfolded by the unfolding means,
wherein the cover body is unfolded from the bottom portion so as to spread out toward a rear side of the aircraft.

2. The shock absorption system according to claim 1, further comprising:
a determination means that determines whether the cover body can be unfolded,
wherein the unfolding means unfolds the cover body if the determination means determines that the cover body can be unfolded.

3. The shock absorption system according to claim 2,
wherein the determination means determines whether the cover body can be unfolded, on the basis of a landing state of a landing gear portion of the aircraft.

4. The shock absorption system according to claim 1,
wherein the shock absorption body is an air bag that contracts while absorbing shock.

5. The shock absorption system according to claim 1,
wherein the shock absorption body is a pipe member that contracts in an axial direction while absorbing shock.
